(19) United States
(12) Patent Application Publication
(10) Pub. No.: US 2024/0078242 A1
(43) Pub. Date: Mar. 7, 2024

(54) ORDER OF TRUST CONSOLIDATION

(71) Applicant: Baker Hughes Holdings LLC, Houston, TX (US)

(72) Inventors: Sebastian Ramirez, Houston, TX (US); Sanideep Pathak, Mumbai (IN)

(21) Appl. No.: 17/929,601

(22) Filed: Sep. 2, 2022

(51) Int. Cl. G06F 16/25; G06F 11/30; G06F 16/28

(52) U.S. Cl. CPC G06F 16/25; G06F 11/3048; G06F 16/288

(57) ABSTRACT

Data includes a first dataset with a first set of attributes and a second dataset with a second set of attributes is received. The first dataset and the second dataset are associated with an industrial asset. A first attribute value of a first attribute in the first set of attributes is assigned a first priority value and a second attribute value of the first attribute in the second set of attributes is assigned a second priority value. A third dataset that includes a third set of attributes of the industrial asset is generated. The third set of attributes includes the first attribute. An attribute value between the first attribute value and the second attribute value is selected based on the first priority value and the second priority value. The first attribute of the third set of attributes of the third dataset is set to the selected attribute value.

### TECHNICAL FIELD

This disclosure relates to database value consolidation.

### BACKGROUND

A database is an organized collection of structured information, or data, typically stored electronically in a computer system. Data within a database can be modeled in rows and columns (e.g., in a series of tables) to make processing and data querying efficient. The data can then be easily accessed, managed, modified, updated, controlled, and organized.

The database management system (DBMS) is the software that interacts with end users, applications, and the database itself to capture and analyze the data. The DBMS software additionally encompasses the core facilities provided to administer the database. In some implementations, the DBMS can includes computer hardware running system software for creating and managing databases. The DBMS provides users and programmers with a systematic way to create, retrieve update and manage data in a database. Examples of databases include relational database, flat database, object oriented database, hierarchical database etc.

### SUMMARY

This disclosure relates to technologies involving order of trust consolidation, for example, in databases. Various aspects of the disclosed subject matter may provide one or more of the following capabilities.

An example of the subject matter described within this disclosure is a method with the following features. Data that includes a first dataset including a first set of attributes and a second dataset including a second set of attributes is received. The first dataset and the second dataset are associated with an industrial asset of an industrial enterprise. A first attribute value of a first attribute in the first set of attributes is assigned a first priority value and a second attribute value of the first attribute in the second set of attributes is assigned a second priority value. A third dataset that includes a third set of attributes of the industrial asset is generated. The third set of attributes includes the first attribute. An attribute value between the first attribute value and the second attribute value is selected based on the first priority value and the second priority value. The first attribute of the third set of attributes of the third dataset is set to the selected attribute value.

Aspects of the example method, which can be combined with the example method alone or in combination with other aspects, include the following. The first set of attributes of the first dataset is mapped to a first set of attributes in the third set of attributes of the third dataset. The second set of attributes of the second dataset is mapped to a second set of attributes in the third set of attributes of the third dataset. The first attribute in the first set of attributes and the first attribute in the second set of attributes are mapped to the first attribute in the third plurality of attributes.

Aspects of the example method, which can be combined with the example method alone or in combination with other aspects, include the following. Selecting the attribute value includes selecting the first attribute value when the first priority value is indicative of greater trust than the second priority value.

Aspects of the example method, which can be combined with the example method alone or in combination with other aspects, include the following. The first attribute is an identity of the industrial asset.

Aspects of the example method, which can be combined with the example method alone or in combination with other aspects, include the following. The first dataset is generated by a first application and the second dataset is generated by a second application of a monitoring system configured to monitor an operation of the industrial asset.

Aspects of the example method, which can be combined with the example method alone or in combination with other aspects, include the following. The first priority value of the first attribute is determined based on the first attribute and the first application. The second priority value of the first attribute is determined based on the first attribute and the second application.

Aspects of the example method, which can be combined with the example method alone or in combination with other aspects, include the following. The first dataset and the second dataset include a first attribute. A first value of the first attribute is different from a second value of the second attribute.

Aspects of the example method, which can be combined with the example method alone or in combination with other aspects, include the following. The first dataset and the second dataset include a first attribute. The first set of attributes is different from the second set of attributes.

An example implementation of the subject matter described within this disclosure is a system with the following features. A non-transitory computer readable storage medium includes instructions for a processor to perform the following. Data that includes a first dataset including a first set of attributes and a second dataset including a second set of attributes is received. The first dataset and the second dataset are associated with an industrial asset of an industrial enterprise. A first attribute value of a first attribute in the first set of attributes is assigned a first priority value and a second attribute value of the first attribute in the second set of attributes is assigned a second priority value. A third dataset that includes a third set of attributes of the industrial asset is generated. The third set of attributes includes the first attribute. An attribute value between the first attribute value and the second attribute value is selected based on the first priority value and the second priority value. The first attribute of the third set of attributes of the third dataset is set to the selected attribute value.

Aspects of the example system, which can be combined with the example system alone or in combination with other aspects, include the following. The instructions further instruct the processor to perform the following. The first set of attributes of the first dataset is mapped to a first set of attributes in the third set of attributes of the third dataset. The second set of attributes of the second dataset is mapped to a second set of attributes in the third set of attributes of the third dataset. The first attribute in the first set of attributes and the first attribute in the second set of attributes are mapped to the first attribute in the third plurality of attributes.

Aspects of the example system, which can be combined with the example system alone or in combination with other aspects, include the following. The first attribute is an identity of the industrial asset.

Aspects of the example system, which can be combined with the example system alone or in combination with other aspects, include the following. The first dataset is generated by a first application and the second dataset is generated by a second application of a monitoring system configured to monitor an operation of the industrial asset.

Aspects of the example system, which can be combined with the example system alone or in combination with other aspects, include the following. The first priority value of the first attribute is determined based on the first attribute and the first application. The second priority value of the first attribute is determined based on the first attribute and the second application.

Aspects of the example system, which can be combined with the example system alone or in combination with other aspects, include the following. The first dataset and the second dataset include a first attribute. A first value of the first attribute is different from a second value of the second attribute.

Aspects of the example system, which can be combined with the example system alone or in combination with other aspects, include the following. The first set of attributes are different from the second set of attributes.

An example of the subject matter describes within this disclosure is a non-transitory readable memory that includes instructions to perform the following steps Data that includes a first dataset including a first set of attributes and a second dataset including a second set of attributes is received. The first dataset and the second dataset are associated with an industrial asset of an industrial enterprise. A first attribute value of a first attribute in the first set of attributes is assigned a first priority value and a second attribute value of the first attribute in the second set of attributes is assigned a second priority value. A third dataset that includes a third set of attributes of the industrial asset is generated. The third set of attributes includes the first attribute. An attribute value between the first attribute value and the second attribute value is selected based on the first priority value and the second priority value. The first attribute of the third set of attributes of the third dataset is set to the selected attribute value.

Aspects of the example non-transitory readable memory, which can be combined with the example non-transitory readable memory alone or in combination with other aspects, include the following. The instructions further include the following steps. The first set of attributes of the first dataset is mapped to a first set of attributes in the third set of attributes of the third dataset. The second set of attributes of the second dataset is mapped to a second set of attributes in the third set of attributes of the third dataset. The first attribute in the first set of attributes and the first attribute in the second set of attributes are mapped to the first attribute in the third plurality of attributes.

Aspects of the example non-transitory readable memory, which can be combined with the example non-transitory readable memory alone or in combination with other aspects, include the following. The first dataset is generated by a first application and the second dataset is generated by a second application of a monitoring system configured to monitor an operation of the industrial asset.

Aspects of the example non-transitory readable memory, which can be combined with the example non-transitory readable memory alone or in combination with other aspects, include the following. The first priority value of the first attribute is determined based on the first attribute and the first application. The second priority value of the first attribute is determined based on the first attribute and the second application.

Aspects of the example non-transitory readable memory, which can be combined with the example non-transitory readable memory alone or in combination with other aspects, include the following. The first set of attributes are different from the second set of attributes.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

These and other capabilities of the disclosed subject matter will be more fully understood after a review of the following figures, detailed description, and claims.

### BRIEF DESCRIPTION OF THE FIGURES

These and other features will be more readily understood from the following detailed description taken in conjunction with the accompanying drawings, in which:

FIG. 1 is a flow chart of an exemplary method for generating a consolidated dataset of an industrial machine;

FIG. 2 is an exemplary first dataset of the industrial machine;

FIG. 3 is an exemplary second dataset of the industrial; and

FIG. 4 is an exemplary consolidated dataset generated from the first and the second dataset.

### DETAILED DESCRIPTION

Any industrial asset can go through multiple stages in its lifetime when it is monitored by different users and applications in the monitoring system. Many of these users/applications may not follow the same standard and can generate a separate dataset associated with the asset based on the context in which the application operates. For example, name of the assets can change over the life of the asset (e.g., different names can be assigned to the asset by different users/applications). It can be desirable to correlate the information in the different dataset and generate a consolidated record of the industrial asset (e.g., during the different stages that the well went through during its lifetime) and treat it as a source of truth.

The priority values can be based on both the attribute type and the source of the attribute value. The first dataset can be generated by a government source and the second dataset can be generated by an on-field technician. If the first attribute is the name of the industrial asset (or asset name attribute), the priority value associated with an asset name attribute in the first dataset (generated by the government) will be given higher priority than the name attribute in the second dataset generated by the on-field technician (e.g., the first priority value is greater than the second priority value). Alternately, if a second first attribute is the location of the asset (or asset location), the priority value associated with the asset location attribute in the second dataset is given higher priority over the asset location attribute in the first dataset. Attributes associated with a given field in the dataset can have different values based on the context of the first and the second application that generate the first and the second dataset respectively. For example, name of the asset can change based on the application.

The subject matter described within this application allows for consolidation of data across various applications and systems to allow for standardization across systems. Such standardization reduces the risk of miscommunications and data mismanagement across an organization or multiple organizations. Such standardization is done by assigning a trust value to attributes managed by various systems, and consolidating the most trusted available attribute values into a single, consolidated database or dataset.

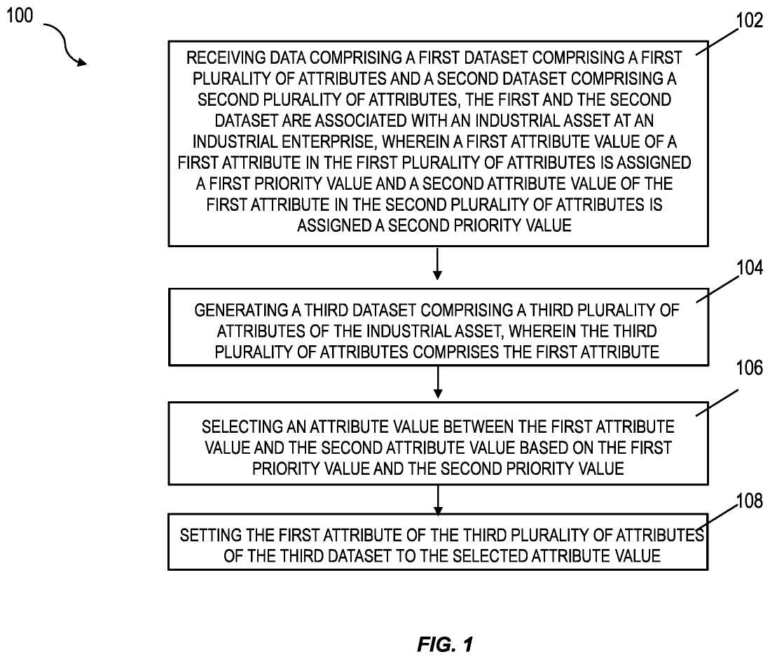

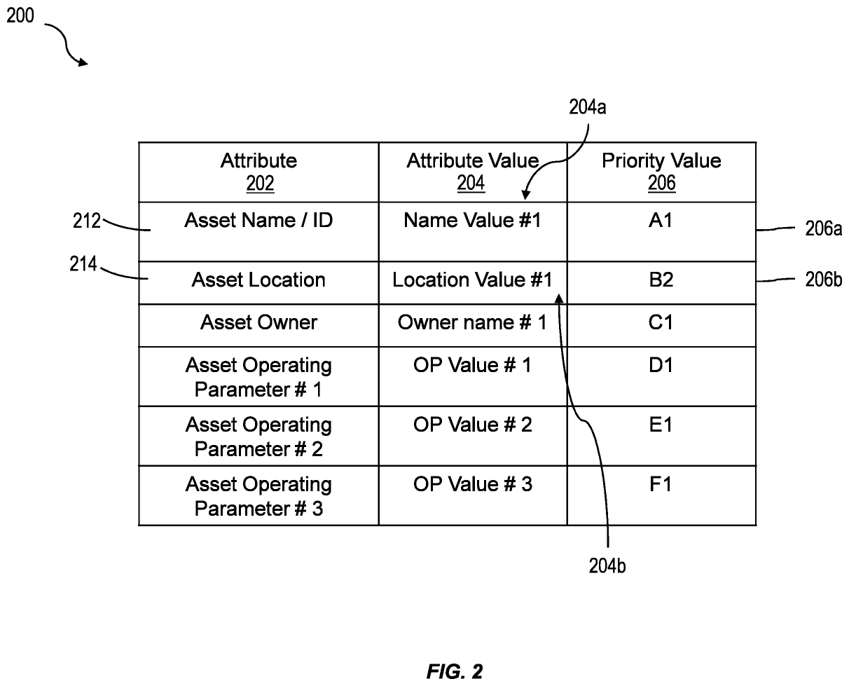

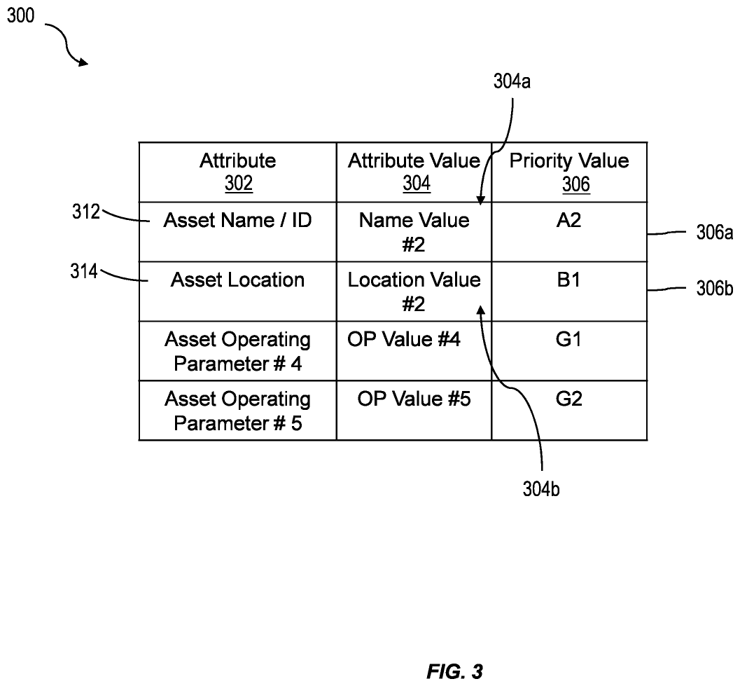

FIG. 1 is a flow chart of an exemplary method 100 for generating a consolidated dataset of the industrial machine. At 102, data that includes a first dataset and a second dataset is received. An example first dataset 200 is illustrated in FIG. 2 and an example second dataset 300 is illustrated in FIG. 3. The following description refers to FIGS. 1-3. The first dataset 200 that includes a first set of attributes 202 and the second dataset includes a second set of attributes 302. The first dataset 200 and the second dataset 300 are associated with an industrial asset at an industrial enterprise. A first attribute value 204a of a first attribute 212 in the first set of attributes 202 is assigned a first priority value 206a and a second attribute value 304a of the first attribute 312 in the second set of attributes 300 is assigned a second priority value 306a. In some implementations, the first dataset 200 is generated by a first application and the second dataset 300 is generated by a second application. Such applications can be used to monitor or simulate operations of the industrial asset. The first dataset 200 and the second dataset 300 each include a first attribute (212, 312), for example, an identity of the industrial asset. In some instances, a first value 204a of the first attribute 212 in the first data set 200 is different from a first value 304a of the first attribute 312 in the second dataset 300. In some implementations, the first data set 200 has a different set of attributes 202 from the attributes 302 within the second dataset 300. For example, the first dataset 200 may include a first operating parameter 218 while the second dataset 300 may include a fourth operating parameter 316 that is not present in the first dataset 200. The different attributes stored in different datasets can be consolidated into a new dataset that includes the attributes of the different datasets.

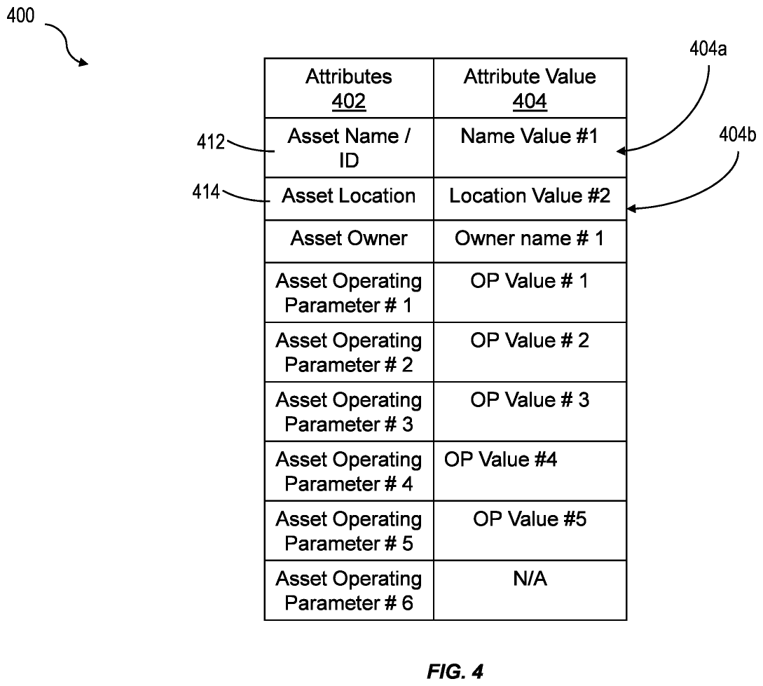

At 104, a third, consolidated dataset 400 (FIG. 4) is generated. The consolidated dataset 400 includes a third set of attributes 402 of the industrial asset. The third set of attributes 402 includes a first attribute 412. In the illustrated examples, the first attribute 412 is the same attribute as the first attribute 312 and the first attribute 212; however, the attribute value can vary between datasets. In creating the consolidated dataset 400, the first set of attributes 202 of the first dataset 200 is mapped to the third set of attributes 402 of the consolidated dataset 400. In addition, the second set of attributes 302 of the second dataset 300 is mapped to the third set of attributes 402 of the consolidated dataset 400. For example in instances where the first attribute 212 in the first set of attributes 202 and the first attribute 312 in the second set of attributes 302 is mapped to the first attribute 412 in the third set of attributes 402. In some instances, the two contributing first attribute values (204a, 304a) do not match.

In such instances, at 106, an attribute value is selected between the first attribute values (204a, 304a) based on the priority value 206a of the first attribute 212 of the first dataset 200 and the priority value 306a of the first attribute 314 in the second dataset 300. The priority values are indicative of a level of trust. That is, one dataset may be considered more trustworthy for certain assets than another data source.

At 108, the first attribute value 404a of the third, or consolidated, set of attributes 402 is set to the selected attribute value from one of the contributing datasets. For example, in some instances, the first dataset 200 is from a government registration application, and the second dataset 300 is from a local management application. In such a situation, the first attribute 212 has an attribute value 204a that is an official identification, while the first attribute 312 has an attribute value 304a that is a shorthand for local operators. In such an instance, the level of trust is higher in the first dataset 200 for the first attribute 212. As such, the priority value 206a is greater (or otherwise indicated as more trustworthy) than the priority value 306a of asset 312. As such, in this example, the asset value 206a is used or copied to attribute value 404a in the consolidated dataset.

It should be noted that each attribute in each dataset has its own priority value, which means some attributes may have a higher priority value in one dataset, and other attributes may have a higher priority value in another dataset. Returning to the previously described example, the attribute 214 in the first dataset 200 (government data in this example) may be considered a less trustworthy source than attribute 314 (local data in this example). For example, the official government location value 204b may simply refer to a general location, such as a leased block of land, while the local location value 304b may refer to a specific wellsite or coordinates. In such an example, the priority value 306b has a higher value (or otherwise indicated as more trustworthy) than the priority value 206b. As such, in this example, the asset value 306b is used or copied to attribute value 406a. This process is repeated until the consolidated dataset 400 has attribute values 404 assigned to all of the corresponding attributes 402 that have datasets with such attributes. In instances where a dataset does not have an attribute value, then the attribute value is taken from a different dataset, or it is left blank or unassigned.

In some implementations, source code can be human-readable code that can be written in program languages such as python, C++, etc. In some implementations, computer-executable codes can be machine-readable codes that can be generated by compiling one or more source codes. Computer-executable codes can be executed by operating systems (e.g., linux, windows, mac, etc.) of a computing device or distributed computing system. For example, computer-executable codes can include data needed to create runtime environment (e.g., binary machine code) that can be executed on the processors of the computing system or the distributed computing system.

Other embodiments are within the scope and spirit of the disclosed subject matter. For example, the method of generating consolidate dataset described in this application can be used in facilities that have complex machines with multiple operational parameters. Usage of the word “optimize”/“optimizing” in this application can imply “improve”/“improving.”

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
receiving data comprising first dataset including a first plurality of attributes and a second dataset including a second plurality of attributes, the first dataset and the second dataset are associated with an industrial asset of an industrial enterprise,
wherein a first attribute value of a first attribute in the first plurality of attributes is assigned a first priority value and a second attribute value of the first attribute in the second plurality of attributes is assigned a second priority value;
generating a third dataset including a third plurality of attributes of the industrial asset, wherein the third plurality of attributes includes the first attribute;
selecting an attribute value between the first attribute value and the second attribute value based on the first priority value and the second priority value; and
setting the first attribute of the third plurality of attributes of the third dataset to the selected attribute value.

2. The method of claim 1, further comprising:
mapping the first plurality of attributes of the first dataset to a first set of attributes in the third plurality of attributes of the third dataset; and
mapping the second plurality of attributes of the second dataset to a second set of attributes in the third plurality of attributes of the third dataset,
wherein the first attribute in the first plurality of attributes and the first attribute in the second plurality of attributes are mapped to the first attribute in the third plurality of attributes.

3. The method of claim 1, wherein selecting the attribute value includes selecting the first attribute value when the first priority value is indicative of greater trust than the second priority value.

4. The method of claim 3, wherein the first attribute is an identity of the industrial asset.

5. The method of claim 1, wherein the first dataset is generated by a first application and the second dataset is generated by a second application of a monitoring system configured to monitor an operation of the industrial asset.

6. The method of claim 5, wherein the first priority value of the first attribute is determined based on the first attribute and the first application,
wherein the second priority value of the first attribute is determined based on the first attribute and the second application.

7. The method of claim 1, wherein the first dataset and the second dataset include a first attribute, wherein a first value of the first attribute is different from a second value of the second attribute.

8. The method of claim 1, wherein the first plurality of attributes are different from the second plurality of attributes.

9. A system comprising:
a processor; and
a non-transitory computer readable storage medium comprising instructions for the processor to perform the following:
receive data comprising a first dataset including a first plurality of attributes and a second dataset including a second plurality of attributes, the first dataset and the second dataset are associated with an industrial asset of an industrial enterprise,
wherein a first attribute value of a first attribute in the first plurality of attributes is assigned a first priority value and a second attribute value of the first attribute in the second plurality of attributes is assigned a second priority value;
generate a third dataset including a third plurality of attributes of the industrial asset, wherein the third plurality of attributes includes the first attribute;
select an attribute value between the first attribute value and the second attribute value based on the first priority value and the second priority value; and
set the first attribute of the third plurality of attributes of the third dataset to the selected attribute value.

10. The system of claim 9, wherein the instructions further instruct the processor to perform the following:
map the first plurality of attributes of the first dataset to a first set of attributes in the third plurality of attributes of the third dataset; and
map the second plurality of attributes of the second dataset to a second set of attributes in the third plurality of attributes of the third dataset,
wherein the first attribute in the first plurality of attributes and the first attribute in the second plurality of attributes are mapped to the first attribute in the third plurality of attributes.

11. The system of claim 10, wherein the first attribute is an identity of the industrial asset.

12. The system of claim 9, wherein the first dataset is generated by a first application and the second dataset is generated by a second application of a monitoring system configured to monitor an operation of the industrial asset.

13. The system of claim 12, wherein the first priority value of the first attribute is determined based on the first attribute and the first application,
wherein the second priority value of the first attribute is determined based on the first attribute and the second application.

14. The system of claim 9, wherein the first dataset and the second dataset include a first attribute, wherein a first value of the first attribute is different from a second value of the second attribute.

15. The system of claim 9, wherein the first plurality of attributes are different from the second plurality of attributes.

16. A non-transitory readable memory comprising instructions to perform the following steps:
receive data comprising a first dataset including a first plurality of attributes and a second dataset including a second plurality of attributes, the first dataset and the second dataset are associated with an industrial asset of an industrial enterprise,
wherein a first attribute value of a first attribute in the first plurality of attributes is assigned a first priority value and a second attribute value of the first attribute in the second plurality of attributes is assigned a second priority value;
generate a third dataset including a third plurality of attributes of the industrial asset, wherein the third plurality of attributes includes the first attribute;
select an attribute value between the first attribute value and the second attribute value based on the first priority value and the second priority value; and
set the first attribute of the third plurality of attributes of the third dataset to the selected attribute value.

17. The non-transitory memory of claim 16, wherein the instructions further comprise the following steps:
map the first plurality of attributes of the first dataset to a first set of attributes in the third plurality of attributes of the third dataset; and
map the second plurality of attributes of the second dataset to a second set of attributes in the third plurality of attributes of the third dataset,
wherein the first attribute in the first plurality of attributes and the first attribute in the second plurality of attributes are mapped to the first attribute in the third plurality of attributes.

18. The non-transitory memory of claim 16, wherein the first dataset is generated by a first application and the second dataset is generated by a second application of a monitoring system configured to monitor an operation of the industrial asset.

19. The non-transitory memory of claim 18, wherein the first priority value of the first attribute is determined based on the first attribute and the first application,
wherein the second priority value of the first attribute is determined based on the first attribute and the second application.

20. The non-transitory memory of claim 16, wherein the first plurality of attributes are different from the second plurality of attributes.
